(19) United States
(12) Patent Application Publication
(10) Pub. No.: US 2004/0179472 A1
(43) Pub. Date: Sep. 16, 2004

(54) Shared path protection method and system

(76) Inventors: Farid Khalilzadeh, Allen, TX (US); Rajan Venkata Rao, Ashburn, VA (US); Raghu Rajan, Plano, TX (US); Manish Sinha, Plano, TX (US)

Correspondence Address: BAKER BOTTS L.L.P., 2001 ROSS AVENUE, SUITE 600, DALLAS, TX, 75201-2980, US

(21) Appl. No.: 10/388,784

(22) Filed: Mar. 14, 2003

(51) Int. Cl. H04L 12/26

(52) U.S. Cl. 370/227

(57) ABSTRACT

Method and system for shared path protection within an optical ring network wherein the network includes a plurality of nodes. A traffic signal is forwarded on a working path on a wavelength. The working path includes a drop node. The traffic signal is individually monitored the traffic signal on the wavelength at the drop node for a failure. In response to at least a detection at the drop node of the failure, a protection switching request is generated. In response to at least the protection switching request, the network is provisioned to forward the traffic signal on the wavelength on a protection path to the drop node.

### TECHNICAL FIELD

The present invention relates generally to optical transport systems, and more particularly to a shared path protection method and system.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of transmitting the signals over long distances with very low loss.

Optical networks often employ wavelength division multiplexing (WDM) or dense wavelength division multiplexing (DWDM) to increase transmission capacity. In WDM and DWDM networks, a number of optical channels are carried in each fiber at disparate wavelengths. Network capacity is based on the number of wavelengths, or channels, in each fiber and the bandwidth, or size of the channels. Other optical network architectures include the synchronous optical network (SONET) architecture.

In order to protect traffic signals from interruptions resulting from line cuts or other failures, various protection switching protocols have been devised, including unidirectional path switched ring (UPSR) for path level SONET protection, 1+1 and bidirectional line switched ring (BLSR) for line level SONET protection and 1+1 optical unidirectional path switch ring (OUPSR) at individual channel level for WDM.

### SUMMARY

The present invention provides a method and system for optical share path protection. In a particular embodiment, each protected channel in an optical ring network may be independently and discretely monitored and automatic protection switching (APS) provided on a per channel basis.

In accordance with one embodiment of the present invention, a method and system for shared path protection includes forwarding a traffic signal on a working path on a wavelength. The working path includes a drop node. The traffic signal is individually monitored on the wavelength at the drop node for failure. In response to at least a detection at the drop node of failure, a protection switching request is generated. In response to at least the protection switching request, the network is provisioned to forward the traffic signal on the wavelength on a protection path to the drop node.

Technical advantages of certain embodiments of the present invention include shared path protection at per channel level in the optical domain. Because protection is on a per channel basis, traffic survivability may be improved. In addition, protection wavelengths may be shared by multiple working connections in the optical ring. Thus, overall network capacity is increased. Also, shared path protection may be independent of the number of channels to allow extension to support any suitable band and extendable to support protection for interconnect wavelength division multiplexing (WDM) ring network configurations. In various embodiments, uni- and bi-directional switching may be supported as well as revertive switching, low priority traffic squelching, user requested handling for network maintenance and upgrades including manual, forced and lock out request, contention handling with defined procedures to handle priority based per channel protection and protection switching hierarchy.

Another technical advantage of certain embodiments of the present invention includes faster, more reliable switching with increased traffic survivability in a relatively low-cost environment. In a particular embodiment, switch request and other protection switching messages are broadcast from the drop node on the Ethernet layer in the form of an Ethernet packet. In a particular embodiment, no dedicated bytes are required for signaling. Multiple logical rings may be supported over a single control channel.

It will be understood that the various embodiments of the present invention may include some, all, or none of the enumerated technical advantages. In addition, other technical advantages of the present invention may be readily apparent from the following figures, description and claims.

### BRIEF DESCRIPTION OF THE DRAWINGS

For a more complete understanding of the present invention and its advantages, reference is now made to the following description taken in conjunction with the accompanying drawings, wherein like numerals represent like parts, in which:

FIG. 1 is a block diagram illustrating an optical network in accordance with one embodiment of the present invention;

FIG. 2 is a block diagram illustrating details of the node of the optical network of FIG. 1 in accordance with one embodiment of the present invention;

FIG. 3 is a block diagram illustrating data maintained for each channel at the nodes of the network of FIG. 1 in accordance with one embodiment of the present invention;

FIG. 4 is a state diagram illustrating states of the switch engine in the add node, drop node, and intermediate node for a channel of the network of FIG. 1 in accordance with one embodiment of the present invention;

FIG. 5 is a block diagram illustrating a signaling packet for protection switching in the network of FIG. 1 in accordance with one embodiment of the present invention;

FIG. 6 is a flow diagram illustrating a method for optical shared path protection of a channel at a drop node of the channel in accordance with one embodiment of the present invention;

FIG. 7 is a flow diagram illustrating a method for optical shared path protection of a channel at an intermediate node of the channel in accordance with one embodiment of the present invention; and

FIG. 8 is a flow diagram illustrating a method for optical shared path protection of a channel at an add node of the channel in accordance with one embodiment of the present invention.

### DETAILED DESCRIPTION

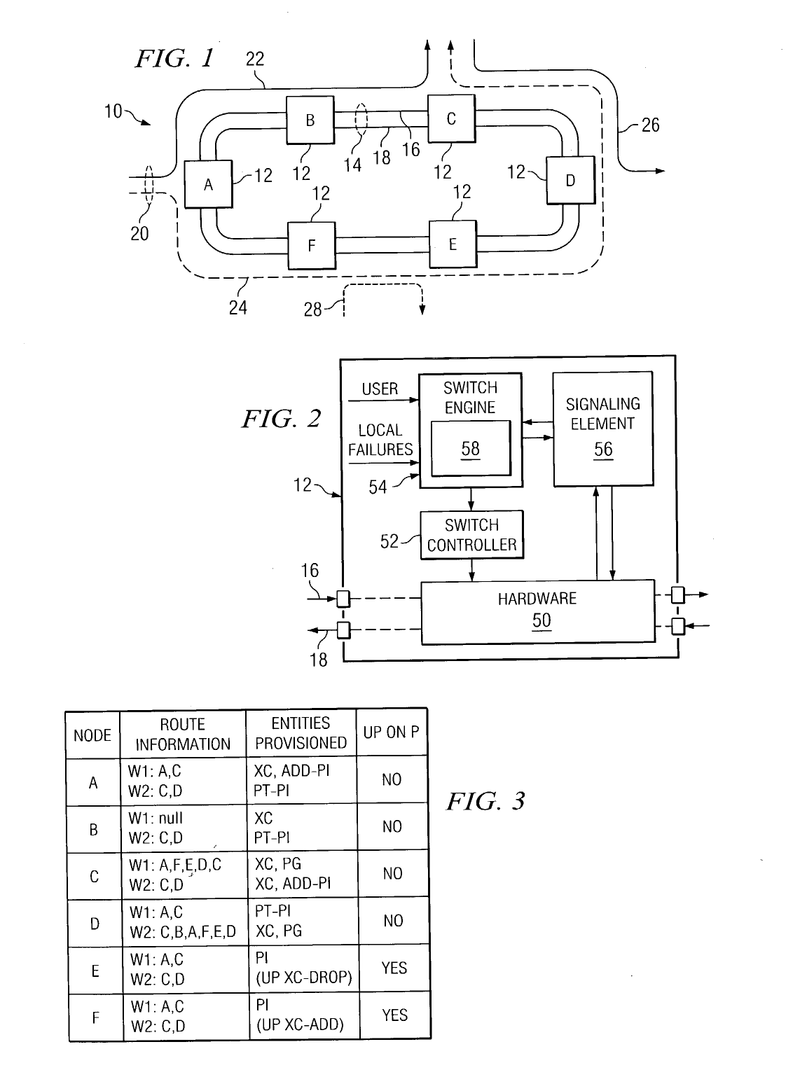

FIG. 1 illustrates an optical network 10 in accordance with one embodiment of the present invention. In this embodiment, the network 10 is an optical network in which a number of optical channels are carried over a common path at disparate wavelengths. The network 10 may be a wavelength division multiplexing (WDM) network, dense wavelength division multiplexing (DWDM) network, or other suitable multi-channel network. The network 10 may be used in a short-haul metropolitan network, and long-haul inter-city network or any other suitable network or combination of networks. The optical signals have at least one characteristic modulated to encode audio, video, textual, real-time, non-real-time and/or other suitable data. Modulation may be based on phase shift keying (PSK), intensity modulation (IM) and other suitable methodologies.

Referring to FIG. 1, network 10 includes a plurality of nodes 12 connected by a ring 14. In the illustrated embodiment, ring 14 comprises a first optical fiber 16 and a second optical fiber 18. It will be understood that ring 14 may in other embodiments comprise a single unidirectional fiber, a single bidirectional fiber, or other suitable ring. In the illustrated embodiment, fiber 16 transports traffic in a clockwise direction, and fiber 18 transports traffic in a counterclockwise direction.

Nodes 12 are operable to add and drop traffic from network 10 and to transmit traffic to and receive traffic from each neighboring node. As used herein, the term “each” means every one of at least a subset of the identified items. Nodes 12 are further operable to transmit, store, and receive signaling messages, including switch requests, acknowledgements, and other suitable messages for shared path protection. The signaling messages may be transmitted in an optical supervisory channel (OSC), or otherwise. Nodes 12 are described in further detail in reference to FIG. 2.

Traffic signals on network 10 may be classified as protected traffic, unprotected preemptable (UP) traffic and unprotected unpreemptable (UU) traffic. Protected traffic is carried on a working path during normal operations and on a protection path during a failure on the working path. UP traffic is not protected and subject to preemption to provide a protection path for protected traffic. Thus, UP traffic is subject to squelching or other termination during protection switching. UU traffic is not protected, but also not preempted during protection switching of other channels.

For ease of reference, nodes 12 of FIG. 1 are individually labeled with the letters A-F. An exemplary protected traffic signal 20 is added to network 10 at node A and dropped from network 10 at node C. The traffic signal includes a working path 22 and a protection path 24. The working path 22 of traffic signal 20 is defined as the path in the clockwise direction from node to A to B and B to C. For the working path 22 of traffic signal 20, therefore, node A comprises an add node, node C comprises a drop node, and node B is an intermediate node. Traffic signal 20 may travel on a selected channel or wavelength, λₓ.

The protection path 24 for traffic signal 20 may be defined as the path from node A to node C in the opposite direction of the working path, in this case the counter clockwise direction via intermediate nodes F, E and D. During normal operations, traffic signal 20 continues to be forwarded on working path A-B-C. It will be understood that traffic signal 20 is an exemplary traffic signal only and that network 10 may in various embodiments comprise a plurality of traffic signals, that some, all, or none of the nodes 10 may act as add, drop, and/or intermediate nodes for a particular traffic signal, and that other working and protection paths may be thereby defined.

A second protected traffic signal 26 may be carried on λₓ. Exemplary signal 26 is added for working path at node C and dropped at node D. Signal 26 has a protection path (not shown) from node C to node D in a counterclockwise direction via intermediate nodes B, A, F and E.

A third traffic signal 28 may be carried on λₓ, and added to network 10 node F and dropped from network 10 at node E, travelling in a counter clockwise direction. Traffic signal 28 may comprise a preemptable UP traffic signal. In a particular embodiment, preemptable traffic signal 26 may comprise a lower priority traffic signal than traffic signals 20 and 26.

In the event of a line cut, interruption or other failure of working path 22 (A-B-C of signal 20), network 10 may be provisioned to forward traffic signal 20 along protection path 24 (A-F-E-D-C). So as to avoid interference, UP traffic signal 28 may be first squelched or otherwise terminated. In this way, overall network capacity may be increased during normal operations by allowing promptable traffic signals to travel on the protection paths of protectable traffic signals. Promptable traffic signal 28 may be similarly terminated to clear the protection path for protected signal 26. In addition, several protected channels may share a protection path with protection switching provided by an optical share path protection ring (OSPPR) protocol.

FIG. 2 illustrates details of a node 12 of the optical network of FIG. 1 in accordance with one embodiment of the present invention. In the illustrated embodiment, node 12 comprises hardware 50, switch controller 52, switch engine 54, and signaling element 56. Hardware 50 may comprise switches, various connects, splitters, multiplexers, demultiplexers, amplifiers or other suitable optional and electrical components (not specifically illustrated) for the adding, dropping, forwarding, or receiving of traffic signals to and from network 10 and to and from local subscribers. For simplicity, only selected elements of node 12 are shown, and node 12 may further comprise other suitable elements. For example, node 12 may comprise an element management system (EMS) and/or a network management system (NMS) and/or other elements or parts of the described nodes or networks for performing network and/or node monitoring, loopback or localized testing functionality of network 10, or other suitable operations.

Switch engine 54 implements the OSPPR protocol for network 10. In one embodiment, switch engine 54 includes a data structure or memory 58 that stores channel and protection state information. In this embodiment, channel information may include wavelength, route, entities provision and unprotected, preemptable on protection (UP on P) information. The route information may include the add, intermediate protect and drop node for each protected channel dropped at the node, the add and drop node for each protected channel added at the node and the add and drop nodes for each protection channel for which the node is an intermediate protect node. FIG. 3 illustrates and further describes the channel information. Different or other suitable information operable to identify channel characteristics for OSPPR may be stored in memory 58.

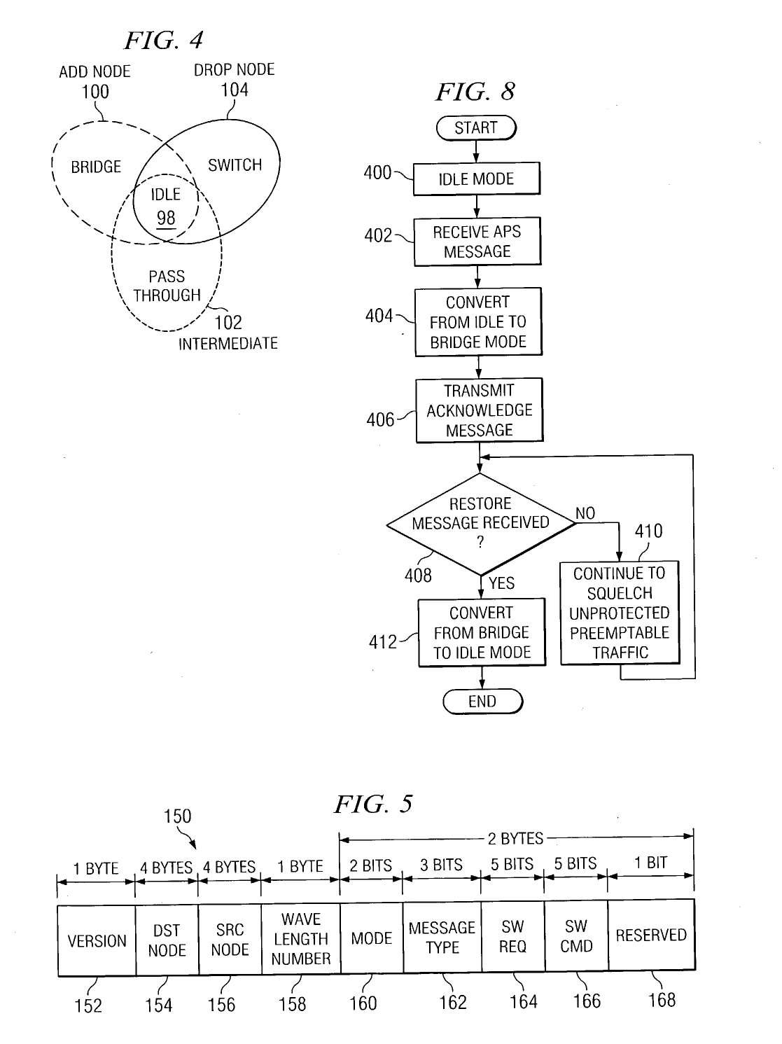

The state information may include for each channel any currently active protection switching requests, the originator of the request and the switch state for the channel. In an embodiment in which the channel is monitored at the drop node, the originator may be the drop node for the channel. The switch state may be idle, bridge, switch or pass through. The switch states are illustrated and further described in connection with FIG. 4.

In operation, switch engine 54 receives user requests and indications of locally detected failures from element or elements of the node 12 and generates protection switching requests for the other nodes 12 of the network 10. In one embodiment, each node monitors each protected drop channel for loss of light (LOL) and initiates protection switching in response to LOL. In this and other embodiments, each channel may be separately and/or distinctly monitored for quality, signal degradation, bit error rate (BER) or other suitable criteria in addition to or in place of LOL. User requests may be received at a local or remote user interface. The switch engine 54 communicates protection switching messages to other nodes of the network 10 through signaling element 56. Switch engine 54 also receives protection switching requests, acknowledgement and other signaling messages generated by nodes 12 of network 10 through signaling element 56.

Switch controller 52 sets the node hardware 50 in response to commands from switch engine 54. Switch controller 52 is further operable to send switch completion message to switch engine 54 in response to completing requested commands.

Signaling element 56 is operable to receive switch requests and acknowledgments from ring 14, to forward those requests and acknowledgments to switch engine 54, and to send requests and acknowledgments from switch engine 54 to ring 14. Signaling element 56 is directly or otherwise coupled to and in communication with hardware 50. In one embodiment, the signaling element 56 communicates with the hardware 50 through the Ethernet layer to expedite protection switching operations. In this embodiment, protection switching may be performed within 50 milliseconds. It will be understood that in other embodiments signaling element 56 or other suitable component may communicate with the switching hardware 50 on the ring through the internet protocol (IP), (TCP), application or other suitable protocol layer.

Switch controller 52, switch engine 54, and signaling element 56 may comprise logic encoded in media for failure detection, protection switching, termination of unprotected traffic signals, and other suitable operations. Logic may comprise software encoded in a disk or other computer-readable medium and/or instructions encoded in an application specific integrated circuit (ASIC), field programmable gate array (FPGA), or other processor or hardware. In one embodiment, the switch engine 54 and signaling element may be an instance for each channel of the network 10 in each node 12. It will be understood that functionality of switch controller 52, switch engine 54, and/or signaling element 56 may be performed by other components of network 10 and/or be otherwise distributed or centralized.

FIG. 3 illustrates data maintained for each channel at exemplary nodes A-F of network 10 in accordance with one embodiment of the present invention. In this embodiment, nodes 12 store route, entities provision and UP on P information for each protected channel.

Referring to FIG. 3, at node A, data store 58 of switch engine 54 stores for signal 20 (W1) added at node A and dropped at node C, the add and drop node. For signal 26, (W2) added at node C and dropped at node D, data store 58 stores the add and drop nodes. Cross-connect (XC), add-protection information (add-PI) and pass through protection information (PT-PI) are provisioned entities. No UP on P are provisioned.

At node B, switch engine 54 stores in data store 58 a null set for W1 as node B is neither an add, drop or intermediate protect node for W1. For W2, data store identifies add and drop nodes C and D. XC and PT-PI are provisioned entities with no UP on P. At node C, where W1 is dropped, switch engine 54 stores the add node A, intermediate protect nodes F, E and D and drop node C. For W2, the add and drop nodes C and D are stored. XC, protection group (PG) and add-PI are provisioned entities.

At node D, the switch engine 54 stores for W1 add and drop nodes A and C. For signal W2, the switch engine 54 stores add nodes C, intermediate protect nodes B, A, F and E and drop node D. PT-PI, XC and PG are entities provisioned. At node E, the switch engine 54 stores for W1 add node A and drop node C and for signal W2 add node C and drop node D. PI and UP XC-drop are entities provisioned with UP on P. As discussed in more detail below, UP signal 28 is squelched or otherwise terminated in the event of a path failure of W1 or W2 to prevent interference with the signal on the protection path. At node F, switch engine 54 stores for W1 add node A and drop node C and for signal W2 add node C and drop node D. PI and UP XC-add are entities provisioned with UP on P. It will be understood that data identifying route information, the add, intermediate or drop nodes of the route information, the provision entities and UP traffic may be otherwise stored without departing from the scope of the present invention.

FIG. 4 is a block diagram illustrating states of the switch engine 54 for a channel in accordance with one embodiment of the present invention. As previously discussed, a switch engine 54 may be instantiated for each channel at each node. Thus, each node may store the state of each channel on which it is an add, drop or intermediate node.

Referring to FIG. 4, the switch engine 54 may have an idle state 98, a bridge state 100, a pass-through state 102 and a switch state 104. In this embodiment, at the add node for a channel, the switch engine for that channel may have a bridge state 100 or idle state 98. The switch engine 54 is in the idle state 98 during normal operations where the channel is carried on the working path. In response to failure in the working path and/or upon request of the drop node, the switch engine 54 for the channel will transition to the bridge state 100 after any UP traffic on the protection path has been squelched. In the bridge state 100, the switch engine sets the hardware 50 to transmit traffic for the channel on each of the working and protect paths.

For a wavelength in which the node is an intermediate protect node, the switch engine 54 for that wavelength may have the idle state, or mode, 98 or the pass-through state 102. Switch engine 54 remains in idle state 98 during normal operations when the signal is carried on a working path. In response to failure of the working path and/or request from the drop node, the switch engine 54 transitions to the pass-through state 102 to carry the signal on the protection path. UP on P traffic is squelched or otherwise terminated.

Switch engine 54 for a channel for which the node is a drop node may have the idle state 98 and the switch state 104. The switch engine 54 is in the idle state 98 during normal operations when the signal is carried on the working path. In response to a fault in a working path, the state of the switch engine 54 transitions to the switch state 104. In the switch state, the switch engine 54 sets the hardware 50 to receive the signal on the protection path. The working path continues to be monitored in order to determine when the fault has been repaired and transport of the signal may revert to the working path.

FIG. 5 illustrates composition of a protection switching message, or signal, in accordance with one embodiment of the present invention. In this embodiment, the protection switching message is a highest priority Ethernet packet transmitted on a control channel. It will be understood that other suitable types of messages may be used to communicate protection switching requests, acknowledgements, states, routing and other information without departing from the scope of the present invention.

In a particular embodiment, the drop node for a channel detects a fiber cut or other failure of protected traffic and broadcasts instructions on the Ethernet layer to the other nodes 12 of the network 10. Nodes 12 receiving the switching request may likewise broadcast on the Ethernet layer acknowledgments indicating that appropriate state changes, as described above in reference to FIG. 4, have been accomplished. The Ethernet packet of FIG. 5 illustrates a format for such switch requests, acknowledgments, or other suitable messages in accordance with one embodiment of the present invention.

Referring to FIG. 5, Ethernet packet 150 comprises a version field 152 comprising one byte, a destination node field 154 comprising four bytes, a source node field 156 comprising four bytes, a wavelength field 158 comprising one byte, a mode field 160 comprising two bits, a message type field 162 comprising three bits, an explanation field 164 comprising five bits, a switch command field 166 comprising five bits, and a reserved field 168 comprising 1 bit. Each of the fields may comprise binary number corresponding to suitable information for that portion of a message, as described below.

Version field 152 contains information concerning the protocol version number (e.g., version 1.01). Destination node field 154 comprises the internet protocol (IP) address of the destination node for the packet. Source node field 156 comprises the IP address of the node from which the packet is broadcast. Wavelength field 158 comprises the wavelength or channel.

As the OSPPR protocol may be standardized and deployed in various networks of different configurations, the protocol may, in a particular embodiment, be operable for both unidirectional and bidirectional switching. Mode field 160 indicates whether the switching is unidirectional or bidirectional. For a bidirectional pair of channels, both channels are switched to their protection paths in the event of failure of the working path of either channel.

Message type field 162 indicates whether the messages is a switch request, a switch request acknowledgment, or a negative switch request acknowledgment. A switch request acknowledgment indicates that a received switch request has been successfully completed by the source node. A negative switch request acknowledgment indicates that a received switch request was unable to be completed by the source node.

Explanation field 164 comprises an explanation of the command, such as a signal failure, a signal degradation, a lockout of the protection path, a lockout of the working path, a waiting period to restore the network to a pre-switch state, a reverse request, or another suitable explanation. Switch command field 166 comprises the actual command, such as “switch,” “bridge,” “remove UP traffic,” idle,” or another suitable command. In a particular embodiment, the OSPPR protocol may support procedures to perform network maintenance or upgrade work by allowing commands such as “manual,” “forced,” “lockout,” or other suitable requests.

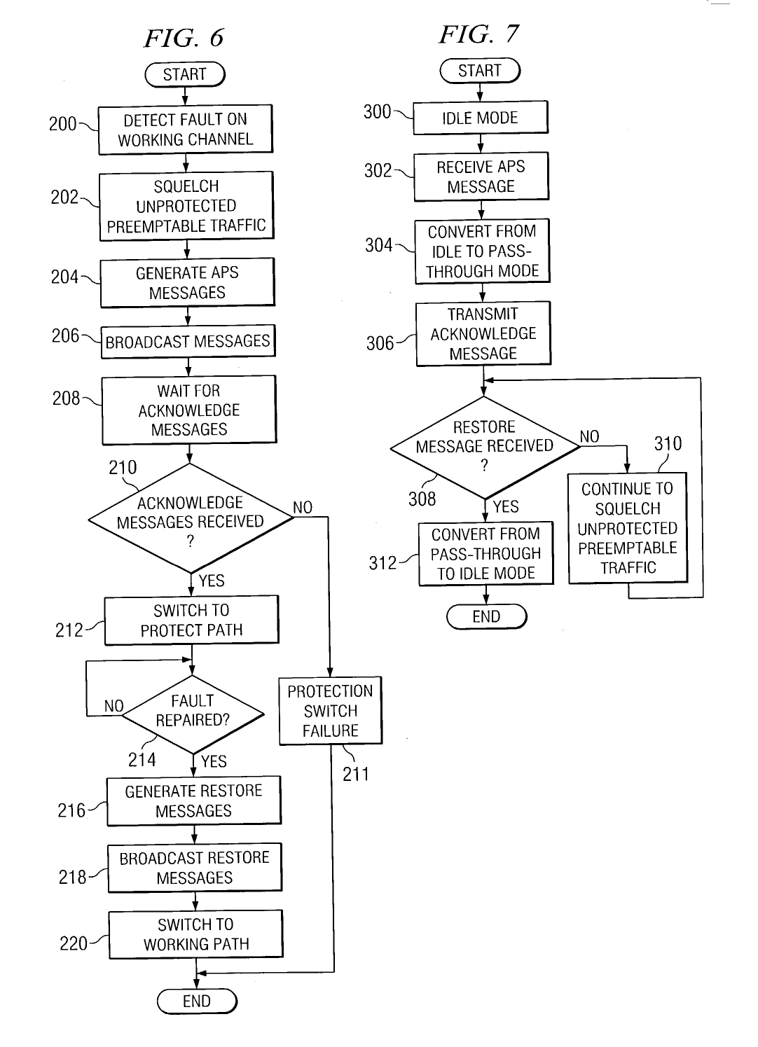

FIG. 6 illustrates a method for optical shared path protection for a channel at a drop node in accordance with one embodiment of the present invention. In this embodiment, each node separately, individually and/or discretely monitors each channel for which it is the drop node for working path failure and/or recovery. In the event of failure, the drop node initiates protection switching. The drop node also initiates switching back to the working path upon recovery.

Referring to FIG. 6, method begins with step 200 wherein failure for a channel is detected at the drop node for that channel. The failure may comprise a line cut, equipment failure, or other failure in the working path of the traffic signal, and may be detected via a LOL detection, increase in BER, or other suitable means.

Proceeding to step 202, UP traffic on the protect path of the channel is squelched or otherwise terminated to prevent interference. In one embodiment, UP traffic on the protect path may be identified by UP on P information in data store 58 of switch engine 54. Upon identifying UP traffic on the protect path, the switch engine 54 may generate and transmit squelch messages to the identified nodes having UP on P traffic. The nodes squelch the UP traffic in response to the messages and each reply with an acknowledgement message. Upon receipt of the squelch acknowledgements, the method proceeds to step 204. If squelched acknowledgement messages are not received, the initiating switch engine 54 may generate a protection switch failure notification. Thus, two phase signaling is used.

At step 204, the switch engine 54 for the channel generates automatic protection switching (APS) messages. Based on stored information for the channel, APS messages are generated for the add and intermediate protect path nodes. The APS messages may comprise Ethernet packets as described in reference to FIG. 5 or other suitable message types.

Proceeding to step 206, the drop node broadcasts the APS messages to the network, such that each node 12 of the network 10 may receive the APS messages and, if a particular node is the destination node for the APS message, act on the APS message. At step 208, the drop node awaits an acknowledgment that protection switching at the add node and intermediate protect nodes have been accomplished. If, at decisional step 210, the acknowledgement messages are not received within a specified period of time, the switch engine 54 times-out and indicates a protection switch failure at step 211. In one embodiment, the time period for receiving acknowledgement messages may be 50 milliseconds.

Upon receipt of acknowledgment messages from the add and intermediate protection nodes indicating that the protection path has been set up and the signal is being transmitted on the protect path, the Yes branch of decisional step 210 leads to step 212 wherein the drop node is provisioned to receive traffic from the protected path. This may be accomplished by transitioning the switch engine 54 from the idle state 98 to the switch state 104.

At decisional step 214, it is determined whether the fault has been repaired or otherwise cleared. Such a determination may be made either through direct path monitoring or through software monitoring. If the fault has not been repaired, the No branch of step 214 leads back to the step input.

When the fault has been cleared, the switch engine 54 may, in a particular embodiment, enter a wait-to-restore state for a predetermined amount of time. In a particular embodiment, the predetermined time may comprise 2 to 12 minutes. Upon expiration of the wait time without further failure on the working path, the method proceeds to step 216 wherein the drop node generates restore messages for the add and intermediate protect nodes 12 of network 10. At step 218, the drop node broadcasts the restore messages. In response to the restore message, the add node transitions out of the bridged state and the intermediate protect nodes drop the protected signal and resume transmitting UP traffic. The add and intermediate protect nodes each acknowledge completion of the reversion request back to the drop node. At step 220, the switch engine 54 at the drop node switches back to the working path. This step may be completed prior to receipt of the acknowledgment messages. If reversion acknowledgements are not received, the switch engine 54 may indicate a reversion failure and/or may continue to receive traffic from the protection path.

FIG. 7 illustrates a method for optical share path protection of a channel at intermediate protect node for the channel in accordance with one embodiment of the present invention. In this embodiment, as previously described, channel failures are detected at the drop node on a discrete channel by channel basis. Automatic protection switching is also provided on a channel by channel basis. Thus, channels may be discretely, separately and/or independently protection switched.

Referring to FIG. 7, the method begins at step 300 with a switch engine 54 for a channel in the idle state 98. As described above in reference to FIG. 4, an idle state 98 comprises normal operations wherein traffic is not being carried on a protection path.

Proceeding to step 302, the node receives an APS message for the channel. At step 304, switch engine 54 transitions from the idle mode, or state, 98 to the pass-through state 102. As described above in reference to FIG. 4, in a pass-through state 102, intermediate protect nodes carry the protected traffic and squelch or otherwise terminate any UP traffic on the protection path. Proceeding to step 306, the intermediate node broadcasts an acknowledgment message indicating that the conversion is complete. The drop node may be the destination node of the acknowledgment message.

Proceeding to determination step 308, if a restore message has not been received by the intermediate node, then the method proceeds to step 310 and unprotected preemptable traffic continues to be squelched. If a restore message has been received, then, at step 312, the switch engine 54 for the channel reverts from a pass-through state 102 to the idle state 98. An acknowledgement message may be generated and transmitted.

FIG. 8 illustrates a method for optical share path protection of a channel at an add node of the channel in accordance with one embodiment of the present invention. In this embodiment, as previously described, channels are independently and discretely monitored at their drop node and independently protection switched in response to a working path failure.

Referring to FIG. 8, the method begins at step 400 with the switch engine 54 for the channel operating in an idle state 98. As described above in reference to FIG. 4, an idle state 98 comprises normal operations wherein traffic is not being carried on a protection path. When in an idle state 98 for a particular channel, the add node transmits traffic for the channel only on a working path.

Proceeding to step 402, the node receives an APS message. At step 404, the switch engine for the channel at the node converts from the idle state 98 to the bridge state 100. As described above in reference to FIG. 4, an add node in a bridge state 100 adds the protected traffic of the particular channel to the designated protection path as well as to the working path. Proceeding to step 406, the add node broadcasts an acknowledgment message indicating that the conversion is complete. The drop node may be the destination node of the acknowledgment message.

At determination step 408, if a restore message has not been received by the add node, then the method proceeds to step 410, wherein the add node continues to add the protected signal to the protection path as well as to the working path. If a restore message has been received, then, at step 412, the switch engine 54 reverts from a bridge state 100 to the idle state 98. An acknowledgement message may be generated and transmitted.

Because a protection path may be shared by two or more working paths, protected signals may be prioritized and in the event of failure of working paths for two or more protected signals with protection being provided for the higher priority signal. Thus, upon a failure, switch engine 54 for the drop node of the channel may first determine whether the protection path is in use by another protected signal due to another failure. If the protection path is already in use, the switch engine 54 may next determine the priority of the already protected signal and if it is higher than the channel of the switch engine 54, not request protection switching until the higher priority signal has reverted back to the working channel. If the already protected signal is of a lower priority, the switch engine 54 may generate and transmit a reversion or idle command for the already protected signal to cause the signal to be terminated from the protection path and thereafter initiate protection switching for the higher priority signal.

Although the present invention has been described with several embodiments, various changes and modifications may be suggested to one skilled in the art. It is intended that the present invention encompass such changes and modifications as fall within the scope of the appended claims.

What is claimed is:

1. A method for shared path protection within an optical ring network, the optical ring network comprising a plurality of nodes, comprising:
forwarding on a working path a traffic signal on a wavelength, the working path comprising a drop node;
individually monitoring the traffic signal on the wavelength at the drop node for a failure;
in response to at least a detection at the drop node of the failure, generating a protection switching request; and
in response to at least the protection switching request, provisioning the network to forward the traffic signal on the wavelength on a protection path to the drop node.

2. The method of claim 1, wherein the protection switching request comprises an Ethernet packet.

3. The method of claim 1, wherein the protection switching request is broadcast from the drop node.

4. The method of claim 1, wherein the forwarding on the working path is in a first direction, and wherein provisioning the network to forward the traffic signal on the wavelength on the protection path comprises at least forwarding the traffic signal in a second direction.

5. The method of claim 1, wherein the traffic signal comprises a protectable traffic signal and further comprising selectively forwarding on the protection path a preemptable traffic signal on the wavelength.

6. The method of claim 5, further comprising, in response to at least the protection switching request, terminating the preemptable traffic signal on the protection path.

7. The method of claim 5, wherein the protectable traffic signal is a higher priority traffic signal than the preemptable traffic signal.

8. A system for shared path protection within an optical ring network, the optical ring network comprising a plurality of nodes, comprising:
means for forwarding on a working path a traffic signal on a wavelength, the working path comprising a drop node;
means for individually monitoring the traffic signal on the wavelength at the drop node for a failure;
means for, in response to at least a detection at the drop node of the failure, generating a protection switching request; and
means for, in response to at least the protection switching request, provisioning the network to forward the traffic signal on the wavelength on a protection path to the drop node.

9. The system of claim 8, wherein the protection switching request comprises an Ethernet packet.

10. The system of claim 8, wherein the protection switching request is broadcast by the drop node.

11. The system of claim 8, wherein the forwarding on the working path is in a first direction, and wherein the means for provisioning the network to forward the traffic signal on the wavelength on the protection path comprises means for at least forwarding the traffic signal in a second direction.

12. The system of claim 8, wherein the traffic signal comprises a protectable traffic signal and further comprising means for selectively forwarding on the protection path a preemptable traffic signal on the wavelength.

13. The system of claim 12, further comprising means for, in response to at least the protection switching request, terminating the preemptable traffic signal on the protection path.

14. The system of claim 12, wherein the protectable traffic signal is a higher priority traffic signal than the preemptable traffic signal.

15. A system for shared path protection within an optical ring network, the optical ring network comprising a plurality of nodes, comprising logic encoded in media, the logic operable to:
forward on a working path a traffic signal on a wavelength, the working path comprising a drop node;
individually monitor the traffic signal on the wavelength at the drop node for a failure;
in response to at least a detection at the drop node of the failure, generate a protection switching request; and
in response to at least the protection switching request, provision the network to forward the traffic signal on the wavelength on a protection path to the drop node.

16. The system of claim 15, wherein the protection switching request comprises an Ethernet packet.

17. The system of claim 15, wherein the protection switching request is broadcast by the drop node.

18. The system of claim 15, wherein logic operable to forward the traffic signal on the working path is operable to forward the traffic signal in a first direction, and wherein the logic operable to provision the network to forward the traffic signal on the wavelength on the protection path comprises logic operable to at least forwarding the traffic signal in a second direction.

19. The system of claim 15, wherein the traffic signal comprises a protectable traffic signal and further comprising logic operable to selectively forward on the protection path a preemptable traffic signal on the wavelength.

20. The system of claim 19, further comprising logic operable to, in response to at least the protection switching request, terminate the preemptable traffic signal on the protection path.

21. The system of claim 19, wherein the protectable traffic signal is a higher priority traffic signal than the preemptable traffic signal.

22. A method for shared path protection within an optical ring network, the optical ring network comprising a plurality of nodes, comprising:
forwarding on a working path a traffic signal on a wavelength in a first direction, the working path comprising a drop node;
forwarding on a protection path a preemptable traffic signal on the wavelength in the second direction, the protection path comprising the drop node;
individually monitoring the traffic signal on the wavelength at the drop node for a failure;
in response to at least a detection at the drop node of the failure, generating a protection switching request comprising an Ethernet packet;
broadcasting from the drop node the protection switching request; and
in response to at least the protection switching request:
provisioning the network to forward the traffic signal on the wavelength on the protection path to the drop node; and
terminating the preemptable traffic signal on the protection path.
